(19) United States
(12) Patent Application Publication
(10) Pub. No.: US 2012/0315531 A1
(43) Pub. Date: Dec. 13, 2012

(54) BATTERY CELL CONNECTION APPARATUS

(75) Inventors: Leonid C. Lev, West Bloomfield, MI (US); Robert S. Conell, Sterling Heights, MI (US); David E. Delaat, Sterling Heights, MI (US)

(73) Assignee: GM GLOBAL TECHNOLOGY OPERATIONS LLC, Detroit, MI (US)

(21) Appl. No.: 13/157,377

(22) Filed: Jun. 10, 2011

(51) Int. Cl. H01M 10/02

(52) U.S. Cl. 429/159

(57) ABSTRACT

A battery component includes electrochemical cells with positive and negative terminals of different metals within a sealed enclosure. A positive terminal and a negative terminal of substantially the same material extend outside the sealed enclosure. The battery component provided enables battery construction which reduces or eliminates exposed welds of different metals. A battery assembly with exposed interconnecting members of the same metal is also provided.

### TECHNICAL FIELD

The invention relates to electrochemical battery modules, and in particular to battery cell stacks or modules having welded cell tab connections.

### BACKGROUND OF THE INVENTION

Multi-cell electrochemical devices, also referred to as battery cell stacks or multi-cell battery modules, can be used for a variety of different applications, including the powering of various electronic devices, for vehicle propulsion, etc. While conventional battery designs such as alkaline, voltaic pile, and lead-acid batteries have been used in countless household and industrial applications for the past few centuries, evolving battery types such as nickel cadmium (NiCd), nickel-metal hydride (Ni-MH), lithium ion, and lithium ion polymer batteries have displayed particular utility in emerging electric and hybrid gas/electric vehicle propulsion applications, due in large part to their superior energy densities. Such batteries are often selectively rechargeable either as plug-in style batteries or onboard during a regenerative braking event, depending on the particular configuration of the vehicle.

### SUMMARY OF THE INVENTION

A battery component includes a plurality of electrochemical cells. Each of the electrochemical cells has a respective positive cell terminal and a respective negative cell terminal. A pouch enclosure defines at least one sealed compartment containing the plurality of electrochemical cells, the positive cell terminals, and the negative cell terminals. A positive enclosure terminal extends from outside the enclosure into the sealed compartment and is in electrical communication with the positive cell terminals. A negative enclosure terminal extends from outside the enclosure into the sealed compartment and is in electrical communication with the negative cell terminals. The positive enclosure terminal and the negative enclosure terminal are both composed primarily of the same metallic chemical element.

The battery component enables the construction of batteries without exposed welds of dissimilar metals, which may improve the quality of welds and improve corrosion resistance. Furthermore, since a single metal is used for all external conductive paths (i.e., all conductive paths outside the sealed compartment), then the metal may be selected on the basis of performance and cost-effectiveness. For example, instead of using both copper and aluminum in the external conductive paths, only aluminum may be used, which has a higher conductivity per unit density and may have a higher conductivity per unit of cost.

Accordingly, a battery assembly is also provided. The battery assembly includes a plurality of pouches. Each of the pouches includes a respective pouch enclosure defining a respective sealed compartment, a respective electrochemical cell inside the enclosure, a respective positive terminal extending from outside the respective pouch enclosure into the respective sealed compartment, and a respective negative terminal extending from outside the respective pouch enclosure into the respective sealed compartment.

A plurality of electrically conductive members operatively interconnects the pouches such that at least one of the terminals of each of the pouches is in electrical communication with one of the terminals on another one of the pouches. The electrically conductive members, the positive terminals, and the negative terminals all comprise the same metal.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic, perspective side view of a battery component including a plurality of electrochemical cells;

FIG. 2 is a schematic, perspective view of a battery assembly having a plurality of battery components that are substantially identical to the battery component of FIG. 1; and

FIG. 3 is a schematic, side view of an alternative connection arrangement for the components of FIG. 2.

### DESCRIPTION OF THE PREFERRED EMBODIMENTS

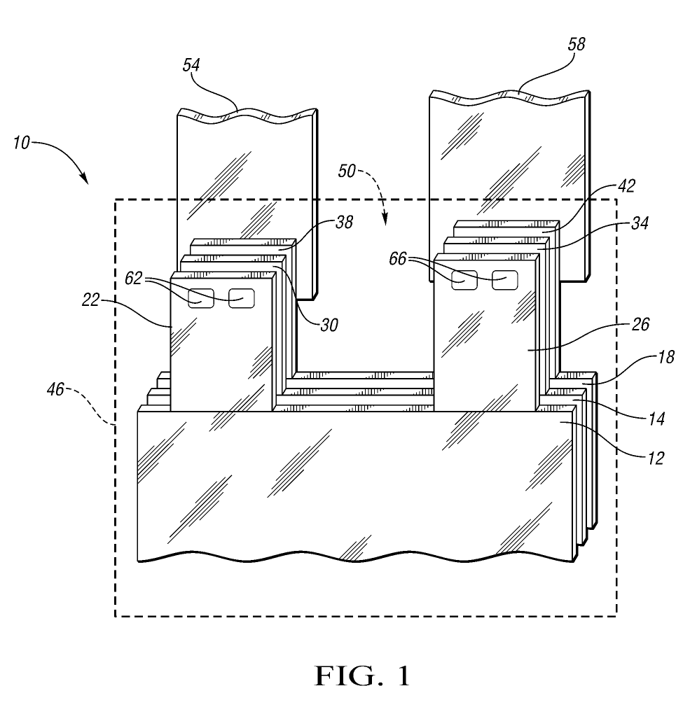

Referring to FIG. 1, a battery component 10 is schematically depicted. The battery component 10 includes a plurality of electrochemical cells 12, 14, 18. Each of the cells 12, 14, 18 has a respective positive cell terminal and a respective negative cell terminal. More specifically, cell 12 includes a positive cell terminal 22 and a negative cell terminal 26; cell 14 includes a positive cell terminal 30 and a negative cell terminal 34; and cell 18 includes a positive cell terminal 38 and a negative cell terminal 42.

The battery component 10 also includes a pouch enclosure 46 that defines at least one sealed compartment. In the embodiment depicted in FIG. 1, the pouch enclosure 46 is formed of flexible foil or metalized polymer film, and defines a single sealed compartment (shown at 50). The sealed compartment 50 contains the plurality of electrochemical cells 12, 14 18, the positive cell terminals 22, 30, 38, and the negative cell terminals 26, 34, 42. More specifically, the electrochemical cells 12, 14 18, the positive cell terminals 22, 30, 38, and the negative cell terminals 26, 34, 42 are entirely enclosed within the sealed compartment 50.

The battery component 10 further includes a positive enclosure terminal 54 and a negative enclosure terminal 58. The positive enclosure terminal 54 extends from outside the enclosure 46 into the sealed compartment 50 and is in electrical communication with the positive cell terminals 22, 30, 38. More specifically, in the embodiment depicted, the positive cell terminals 22, 30, 38 and the positive enclosure terminal 54 are connected to each other by a plurality of welds 62 inside the sealed compartment 50.

Similarly, the negative enclosure terminal 58 extends from outside the enclosure 46 into the sealed compartment 50 and is in electrical communication with the negative cell terminals 26, 34, 42. More specifically, in the embodiment depicted, the negative cell terminals 26, 34, 42 and the negative enclosure terminal 58 are connected to each other by a plurality of welds 66 inside the sealed compartment 50. Accordingly, the plurality of electrochemical cells 12, 14, 18 are interconnected in parallel.

The positive enclosure terminal 54 and the negative enclosure terminal 58 both comprise the same metal, which facilitates battery construction by eliminating or reducing the quantity of exposed welds of dissimilar metals. More specifically, the positive enclosure terminal 54 is composed primarily of a metallic chemical element, and the negative enclosure terminal 58 is composed primarily of the same metallic chemical element as the positive enclosure terminal 54. As used herein, a member “is composed primarily of a metallic chemical element” if the member is at least fifty percent by mass the metallic chemical element. Preferably, the positive enclosure terminal 54 and the negative enclosure terminal 58 are between eighty and one hundred percent by mass the metallic chemical element. If the enclosure terminals are less than one hundred percent the metallic chemical element, then the remainder of the composition may be alloying elements or impurities.

The positive cell terminals 22, 30, 38 are composed primarily of a first metallic chemical element. The negative cell terminals 26, 34, 42 are composed primarily of a second metallic chemical element. In one embodiment in which the electrochemical cells are lithium-ion cells, the first metallic chemical element is aluminum, and the second metallic chemical element is copper. The metallic chemical element of the enclosure terminals 54, 58 may be aluminum, copper, or another metallic chemical element.

The battery component 10 may sometimes be referred to as a “pouch” or “battery subassembly.” A “pouch” may include one or more electrochemical cells within the scope of the claimed invention. In one embodiment, a pouch includes 17-20 electrochemical cells. The pouch enclosure 46 in the embodiment depicted defines a single sealed compartment 50 that contains the electrochemical cells 12, 14, 18 and the welds 62, 66. However, and within the scope of the claimed invention, a pouch enclosure may define a plurality of sealed compartments. For example, in an alternative embodiment, the pouch enclosure may define a first sealed compartment and a second sealed compartment. Electrochemical cells are disposed within the first sealed compartment, and cell terminals extend from the first sealed compartment into the second sealed compartment. Enclosure terminals extend from outside the pouch enclosure into the second sealed compartment, where they are welded to, or otherwise operatively connected to, the cell terminals. Also, and within the scope of the claimed invention, an intermediate conductive member may interconnect the enclosure terminals with the cell terminals inside the sealed compartment.

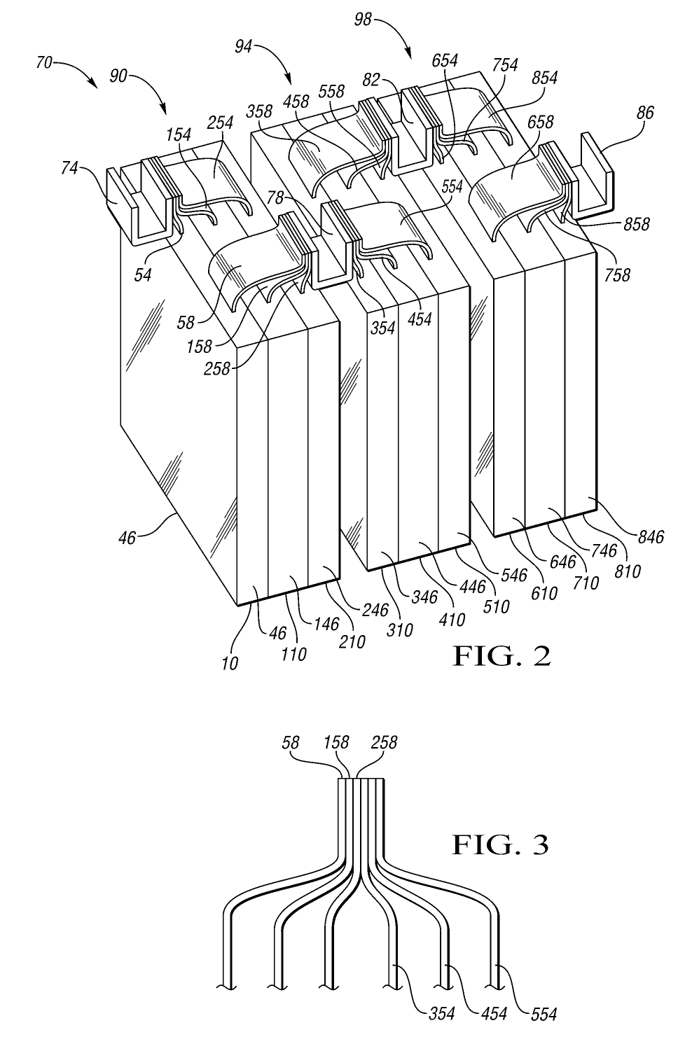

Referring to FIG. 2, wherein like reference numbers refer to like components from FIG. 1, a battery assembly 70 is schematically depicted. The battery assembly 70 includes a plurality of pouches 10, 110, 210, 310, 410, 510, 610, 710, 810. All of the pouches 10, 110, 210, 310, 410, 510, 610, 710, 810 are substantially identical to the pouch shown at 10 in FIG. 1. Thus, each of the pouches includes a respective pouch enclosure defining a respective sealed compartment, a respective electrochemical cell inside the enclosure, a respective positive terminal extending from outside the respective pouch enclosure into the respective sealed compartment, and a respective negative terminal extending from outside the respective pouch enclosure into the respective sealed compartment.

More specifically, pouch 110 includes pouch enclosure 146, a positive enclosure terminal 154, and a negative enclosure terminal 158. Pouch 210 includes pouch enclosure 246, a positive enclosure terminal 254, and a negative enclosure terminal 258. Pouch 310 includes pouch enclosure 346, a positive enclosure terminal 354, and a negative enclosure terminal 358. Pouch 410 includes pouch enclosure 446, a positive enclosure terminal 454, and a negative enclosure terminal 458. Pouch 510 includes pouch enclosure 546, a positive enclosure terminal 554, and a negative enclosure terminal 558. Pouch 610 includes pouch enclosure 646, a positive enclosure terminal 654, and a negative enclosure terminal 658. Pouch 710 includes pouch enclosure 746, a positive enclosure terminal 754, and a negative enclosure terminal 758. Pouch 810 includes pouch enclosure 846, a positive enclosure terminal 854, and a negative enclosure terminal 858.

The battery assembly further includes a plurality of electrically conductive members 74, 78, 82, 86 that operatively interconnect the pouches 10, 110, 210, 310, 410, 510, 610, 710, 810 such that at least one of the terminals of each of the pouches is in electrical communication with one of the terminals of another one of the pouches. The electrically conductive members 74, 78, 82, 86, the positive terminals 54, 154, 254, 354, 454, 554, 654, 754, 854, and the negative terminals 58, 158, 258, 358, 458, 558, 658, 758, 858 are all composed primarily of the same metallic chemical element, such as aluminum.

In the embodiment depicted, pouches 10, 110, 210 form a first plurality of pouches; pouches 310, 410, 510 form a second plurality of pouches; and pouches 610, 710, 810 form a third plurality of pouches. The first plurality of pouches, i.e. pouches 10, 110, 210, are operatively connected to one another in parallel to form a first pack 90; the second plurality of pouches, i.e., pouches 310, 410, 510, are operatively connected to one another in parallel to form a second pack 94; and the third plurality of pouches, i.e., pouches 610, 710, 810, are operatively connected to one another in parallel to form a third pack 98.

More specifically, in the embodiment depicted, the positive terminals 54, 154, 254, 354, 454, 554, 654, 754, 854, and the negative terminals 58, 158, 258, 358, 458, 558, 658, 758, 858 are flexible or bendable tabs. The positive enclosure terminals 54, 154, 254 of pouches 10, 110, 210 are bent into contact and welded to each other and to electrically conductive member 74, and the negative enclosure terminals 58, 158, 258 of pouches 10, 110, 210 are bent into contact and welded to each other and to electrically conductive member 78, and thus the pouches 10, 110, 210 are interconnected in parallel. Similarly, the positive enclosure terminals 354, 454, 554 of pouches 310, 410, 510 are welded to each other and to electrically conductive member 78, and the negative enclosure terminals 358, 458, 558 of pouches 310, 410, 510 are welded to each other and to electrically conductive member 82, and thus the pouches 310, 410, 510 are interconnected in parallel. The positive enclosure terminals 654, 754, 854 of pouches 610, 710, 810 are welded to each other and to electrically conductive member 82, and the negative enclosure terminals 658, 758, 858 of pouches 610, 710, 810 are welded to each other and to electrically conductive member 86, and thus the pouches 610, 710, 810 are interconnected in parallel.

Electrically conductive member 78 provides electrical communication between the negative enclosure terminals 58, 158, 258 of the first pack 90 and the positive enclosure terminals 354, 454, 554 of the second pack 94, and thus the electrically conductive member 78 connects the first pack 90 and the second pack 94 in series. Similarly, electrically conductive member 82 provides electrical communication between the negative enclosure terminals 358, 458, 558 of the second pack 94 and the positive enclosure terminals 654, 754, 854 of the third pack 98, and thus the electrically conductive member 82 connects the second pack 94 and the third pack 98 in series. Other packs (not shown) may be connected in series to the first, second, and third packs 90, 94, 98 via electrically conductive members 74 and 86.

In the embodiment depicted, the electrically conductive members 74, 78, 82, 86 are U-shaped bus bars. Electrically conductive members may have other shapes within the scope of the claimed invention. For example, bus bars may also be open box, open end, or closed within the scope of the claimed invention. Also, and within the scope of the claimed invention, the terminals themselves may be considered “electrically conductive members” that operatively interconnect the pouches. For example, in an alternative embodiment, terminals of one pack are welded directly to the terminals of another stack, thereby eliminating the U-shaped bus bars shown at 74, 78, 82, and 86. Referring to FIG. 3, wherein like reference numbers refer to like components from FIGS. 1 and 2, the negative terminals 58, 158, 258 are shown welded directly together without an intermediate bus bar.

Aluminum has a higher conductivity per unit density than copper, and thus by using aluminum for all exposed electrical connections between and among the terminals, the mass of the battery is reduced compared to batteries that employ both copper and aluminum electrical connections. Aluminum may also have a higher conductivity per unit cost compared to copper, and thus the cost of the battery maybe reduced compared to batteries that employ both copper and aluminum electrical connections. It may be desirable to coat aluminum members with copper or nickel for corrosion protection. The battery assembly provided herein also enables a wider use of welding techniques to connect terminals to each other and/or to bus bars. For example, in addition to ultrasonic welding, resistance welding and laser welding may also be employed.

While the best modes for carrying out the invention have been described in detail, those familiar with the art to which this invention relates will recognize various alternative designs and embodiments for practicing the invention within the scope of the appended claims.

1. A battery component comprising:
a plurality of electrochemical cells, each of the cells having a respective positive cell terminal and a respective negative cell terminal;
an enclosure defining at least one sealed compartment containing the plurality of electrochemical cells, the positive cell terminals, and the negative cell terminals;
a positive enclosure terminal extending from outside the enclosure into said at least one sealed compartment and being in electrical communication with the positive cell terminals; and
a negative enclosure terminal extending from outside the enclosure into said at least one sealed compartment and being in electrical communication with the negative cell terminals;
wherein the positive enclosure terminal is composed primarily of a metallic chemical element; and
wherein the negative enclosure terminal is composed primarily of the same metallic chemical element as the positive enclosure terminal.

2. The battery component of claim 1, wherein the negative enclosure terminal is welded to the negative cell terminals inside said at least one sealed compartment; and
wherein the positive enclosure terminal is welded to the positive cell terminals inside said at least one sealed compartment.

3. The battery component of claim 2, wherein each of the negative cell terminals is composed primarily of the same metallic chemical element as the positive and negative enclosure terminals; and
wherein each of the positive cell terminals is composed primarily of another metallic chemical element different from the metallic chemical element of the positive and negative enclosure terminals.

4. The battery component of claim 2, wherein each of the positive cell terminals is composed primarily of the same metallic chemical element as the positive and negative enclosure terminals; and
wherein each of the negative cell terminals is composed primarily of another metallic chemical element different from the metallic chemical element of the positive and negative enclosure terminals

5. The battery component of claim 1, wherein the electrochemical cells are lithium-ion cells.

6. The battery component of claim 1, wherein the enclosure is foil or metalized film.

7. The battery component of claim 1, wherein the metallic chemical element is aluminum.

8. The battery component of claim 7, wherein the positive cell terminals are composed primarily of aluminum and the negative cell terminals are composed primarily of copper.

9. A battery assembly comprising:
a plurality of battery subassemblies, each of the subassemblies including a respective enclosure defining a respective sealed compartment, a respective electrochemical cell inside the enclosure, a respective positive terminal extending from outside the respective enclosure into the respective sealed compartment, and a respective negative terminal extending from outside the respective enclosure into the respective sealed compartment; and
a plurality of electrically conductive members operatively interconnecting the battery subassemblies such that at least one of the terminals of each of the battery subassemblies is in electrical communication with one of the terminals on another one of the battery subassemblies;
wherein each of the electrically conductive members, the positive terminals, and the negative terminals all comprise alloys are composed primarily of a metallic chemical element.

10. The battery assembly of claim 9, wherein the plurality of battery subassemblies includes a first plurality of battery subassemblies and a second plurality of battery subassemblies; wherein the first plurality of battery subassemblies are operatively connected to one another in parallel to form a first pack; wherein the second plurality of battery subassemblies are operatively connected to one another to form a second pack.

11. The battery assembly of claim 10, wherein the first pack and the second pack are connected to each other in series by at least one of the electrically conductive members.

12. The battery assembly of claim 11, wherein said at least one of the electrically conductive members is a bus bar.

13. The battery assembly of claim 12, wherein the bus bar is U-shaped.

14. The battery assembly of claim 12, wherein the metallic chemical element is aluminum.

15. The battery assembly of claim 11, wherein the positive terminals of the first pack are operatively connected directly to the negative terminals of the second pack.
